(19) United States
(12) Patent Application Publication
(10) Pub. No.: US 2026/0086320 A1
(43) Pub. Date: Mar. 26, 2026

(54) OPTICAL SYSTEM, OPTICAL DEVICE, AND METHOD FOR MANUFACTURING OPTICAL SYSTEM

(71) Applicant: NIKON CORPORATION, Shinagawa-ku, Tokyo (JP)

(72) Inventors: Takuro ONO, Okegawa-shi (JP); Kosuke MACHIDA, Tokyo (JP)

(21) Appl. No.: 19/110,067

(22) PCT Filed: Sep. 27, 2023
(86) PCT No.: PCT/JP2023/035060

§ 371 Date: Mar. 8, 2025

(30) Foreign Application Priority Data
Sep. 28, 2022 (JP) 2022-154686

(51) Int. Cl. G02B 9/60

(52) U.S. Cl. CPC G02B 9/60

(57) ABSTRACT

An optical system (OL) includes a first lens group having positive refractive power, a second lens group having negative refractive power, a third lens group having positive refractive power, a fourth lens group having positive refractive power, and a fifth lens group having negative refractive power, disposed in order from an object along an optical axis, and upon focusing, the second lens group and the fourth lens group move along the optical axis, and the following conditional expression is satisfied:

$$0. 50 < f 1 / f 3 < 2.00$$

where f1: a focal length of the first lens group
f3: a focal length of the third lens group.

### TECHNICAL FIELD

The present invention relates to an optical system, an optical device, and a method for manufacturing the optical system.

### TECHNICAL BACKGROUND

In related art, an optical system suitable for a photographic camera, an electronic still camera, a video camera, and the like, has been proposed (see, for example, Patent literature 1). However, it is difficult to achieve bright and favorable optical performance in such an optical system.

### PRIOR ARTS LIST

### Patent Document

Patent literature 1: Japanese Laid-Open Patent Publication No. 2022-16822 (A)

### SUMMARY OF THE INVENTION

An optical system according to the present invention includes a first lens group having positive refractive power, a second lens group having negative refractive power, a third lens group having positive refractive power, a fourth lens group having positive refractive power, and a fifth lens group having negative refractive power, disposed in order from an object along an optical axis, upon focusing, the second lens group and the fourth lens group move along the optical axis, and the following conditional expression is satisfied:

$$0. 50 < f 1 / f 3 < 2.00$$

where f1: a focal length of the first lens group
f3: a focal length of the third lens group.

An optical device according to the present invention includes the above-described optical system.

A method for manufacturing an optical system according to the present invention is a method for manufacturing an optical system including a first lens group having positive refractive power, a second lens group having negative refractive power, a third lens group having positive refractive power, a fourth lens group having positive refractive power, and a fifth lens group having negative refractive power, disposed in order from an object along an optical axis, upon focusing, the second lens group and the fourth lens group moving along the optical axis, and the method including a step of disposing respective lenses within a lens barrel so that the following conditional expression is satisfied:

$$0.5 < f 1 / f 3 < 2.00$$

where f1: a focal length of the first lens group
f3: a focal length of the third lens group.

### BRIEF DESCRIPTION OF THE DRAWINGS

FIG. 1 is a view illustrating a lens configuration of an optical system according to a first example;

FIG. 2 is various aberration diagrams upon focusing on infinity of the optical system according to the first example;

FIG. 3 is a view illustrating a lens configuration of an optical system according to a second example;

FIG. 4 is various aberration diagrams upon focusing on infinity of the optical system according to the second example;

FIG. 5 is a view illustrating a lens configuration of an optical system according to a third example;

FIG. 6 is various aberration diagrams upon focusing on infinity of the optical system according to the third example;

FIG. 7 is a view illustrating a lens configuration of an optical system according to a fourth example;

FIG. 8 is various aberration diagrams upon focusing on infinity of the optical system according to the fourth example;

FIG. 9 is a view illustrating a lens configuration of an optical system according to a fifth example;

FIG. 10 is various aberration diagrams upon focusing on infinity of the optical system according to the fifth example;

FIG. 11 is a view illustrating a configuration of a camera including the optical system according to the present embodiment; and

FIG. 12 is a flowchart indicating a method for manufacturing the optical system according to the present embodiment.

### DESCRIPTION OF THE EMBODIMENTS

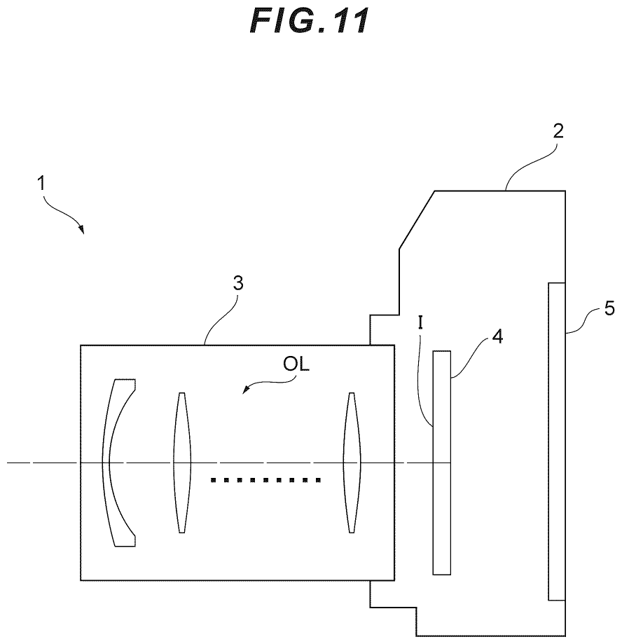

A preferred embodiment according to the present invention will be described below. First, a camera (optical device) including an optical system according to the present embodiment will be described based on FIG. 11. As illustrated in FIG. 11, a camera 1 includes a main body 2, and an imaging lens 3 to be loaded to the main body 2. The main body 2 includes an imaging element 4, a main body control part (not illustrated) that controls operation of a digital camera, and a liquid crystal screen 5. The imaging lens 3 includes an optical system OL having a plurality of lens groups, and a lens position control mechanism (not illustrated) that controls positions of the respective lens groups. The lens position control mechanism includes a sensor that detects the positions of the lens groups, a motor that moves the lens groups backward and forward along an optical axis, a control circuit that drives the motor, and the like.

Light from a subject is focused by the optical system OL of the imaging lens 3 and reaches an image surface I of the imaging element 4. The light from the subject that has reached the image surface I is photoelectrically converted by the imaging element 4 and recorded in a memory (not illustrated) as digital image data. The digital image data recorded in the memory can be displayed on the liquid crystal screen 5 in accordance with operation of a user. Note that the camera may be a mirrorless camera or a single-lens reflex camera having a quick return mirror. Further, the optical system OL illustrated in FIG. 11 schematically illustrates an optical system provided in the imaging lens 3, and a lens configuration of the optical system OL is not limited to this configuration.

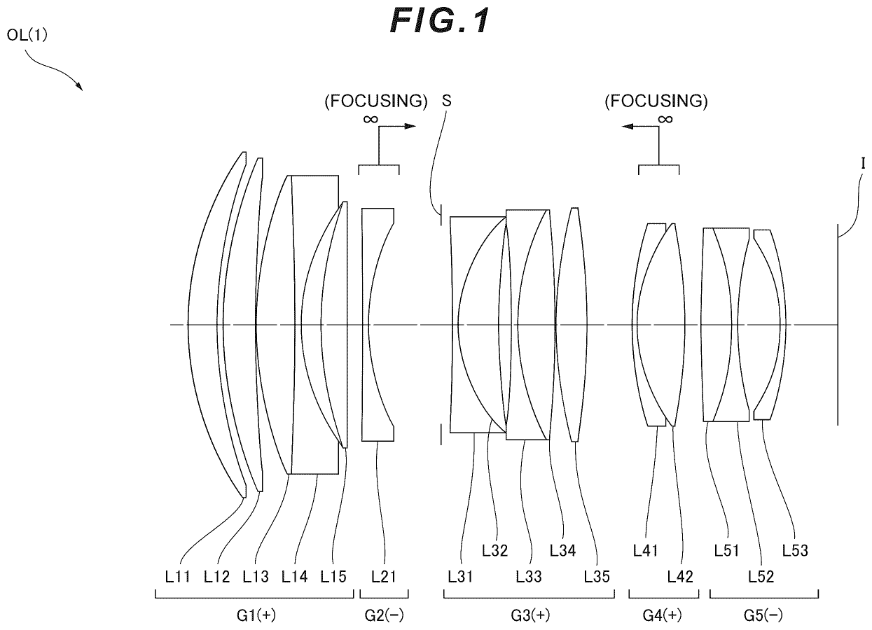

An optical system according to the present embodiment will be described next. As illustrated in FIG. 1, the optical system OL (1) as one example of the optical system OL according to the present embodiment includes a first lens group G1 having positive refractive power, a second lens group G2 having negative refractive power, a third lens group G3 having positive refractive power, a fourth lens group G4 having positive refractive power, and a fifth lens group G5 having negative refractive power, disposed in order from an object along the optical axis. Upon focusing, the second lens group G2 and the fourth lens group G4 move along the optical axis.

Under the above-described configuration, in the optical system OL according to the present embodiment, the following conditional expression (1) is satisfied:

$$0.5 < f 1 / f 3 < 2.00 \qquad ( 1 )$$

where f1: a focal length of the first lens group
f3: a focal length of the third lens group.

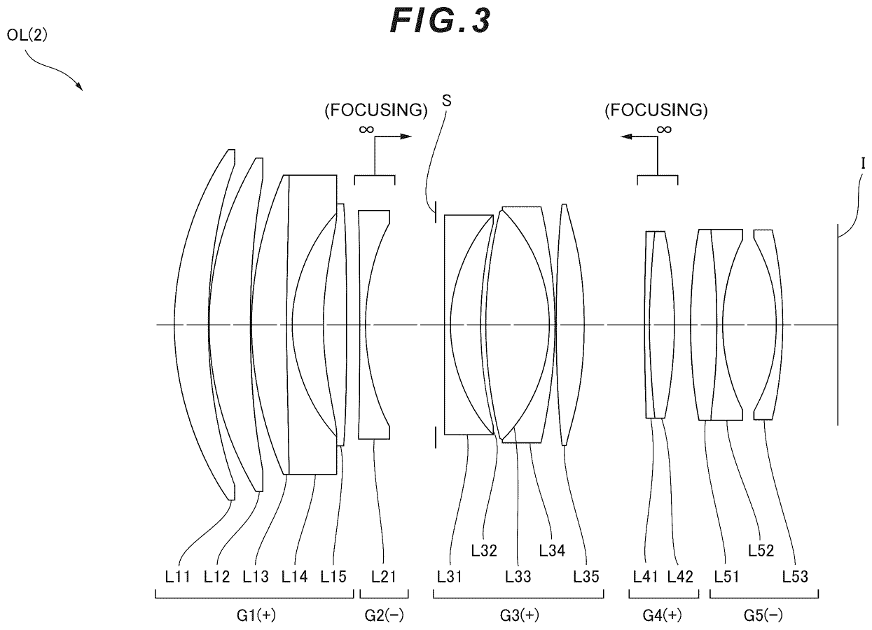

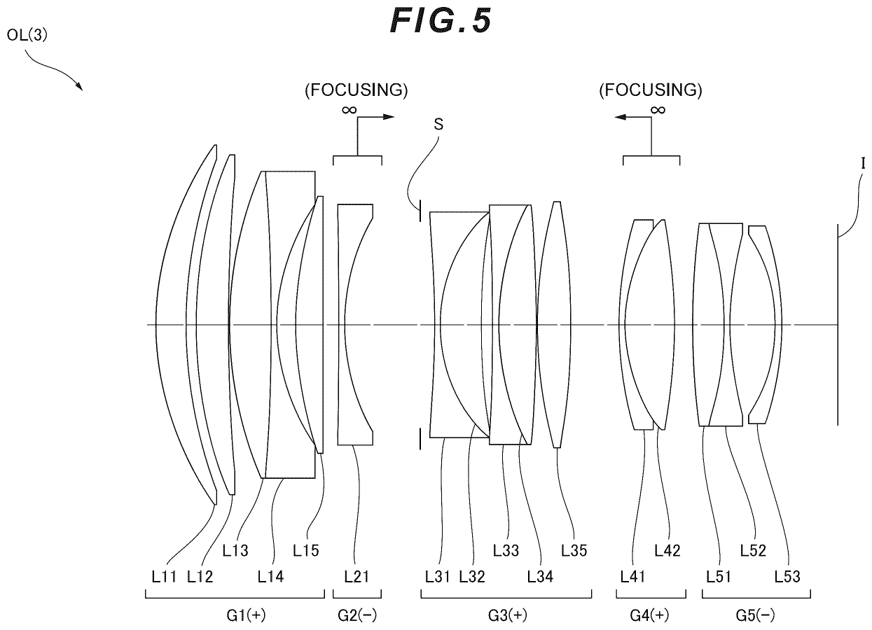

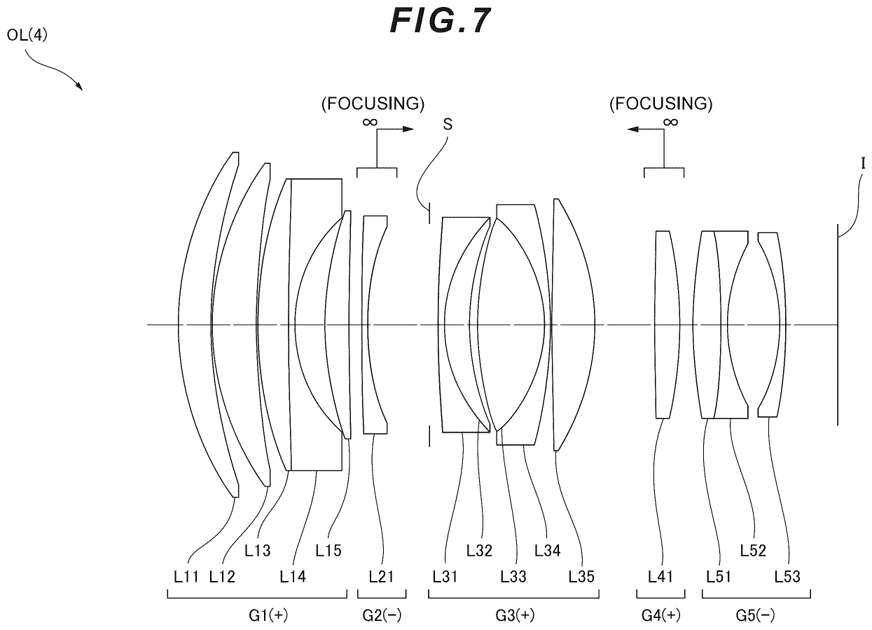

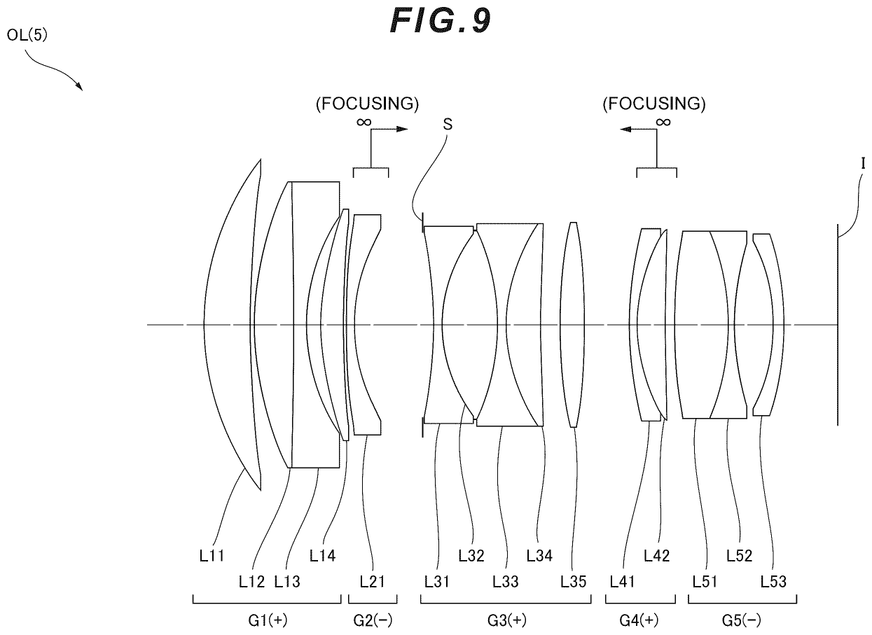

According to the present embodiment, it is possible to obtain a bright optical system having favorable optical performance and an optical device including the optical system. The optical system OL according to the present embodiment may be an optical system OL (2) illustrated in FIG. 3, may be an optical system OL (3) illustrated in FIG. 5, may be an optical system OL (4) illustrated in FIG. 7 or may be an optical system OL (5) illustrated in FIG. 9.

The conditional expression (1) specifies an appropriate range of a ratio of the focal length between the first lens group G1 and the third lens group G3. As a result of the conditional expression (1) being satisfied, various aberrations such as a spherical aberration, a coma aberration, a curvature of field and a distortion can be favorably corrected.

If a corresponding value of the conditional expression (1) exceeds an upper limit value, the refractive power of the first lens group becomes too weak, and thus, a lens radius becomes large and it becomes difficult to achieve a smaller size. By the upper limit value of the conditional expression (1) being set at 1.90, 1.80, 1.70, 1.60, and 1.50, effects of the present embodiment can be made more reliable.

If the corresponding value of the conditional expression (1) falls below a lower limit value, the refractive power of the first lens group becomes too strong, and thus, a high-order spherical aberration, a high-order coma aberration, a high-order curvature of field, and a high-order distortion upon focusing on infinity occur, and it becomes difficult to correct aberrations. By the lower limit value of the conditional expression (1) being set at 0.50, 0.60, 0.70, 0.80 and 0.90, the effects of the present embodiment can be made more reliable.

In the optical system OL according to the present embodiment, the following conditional expression (2) is preferably satisfied:

$$0.3 < ( - f 2 ) / f 3 < 2 \text{.00} \qquad ( 2 )$$

where f2: a focal length of the second lens group G2.

The conditional expression (2) specifies an appropriate range of a ratio of the focal length between the second lens group G2 and the third lens group G3. By the conditional expression (2) being satisfied, various aberrations such as the coma aberration and the curvature of field can be favorably corrected.

If a corresponding value of the conditional expression (2) exceeds an upper limit value, refractive power of the second lens group becomes too weak, and thus, a lens radius becomes large, and it becomes difficult to achieve a smaller size. By the upper limit value of the conditional expression (2) being set at 1.80, 1.60, 1.50, 1.40, and 1.30, the effects of the present embodiment can be made more reliable.

If the corresponding value of the conditional expression (2) falls below a lower limit value, the refractive power of the second lens group becomes too strong, and thus, a high-order coma aberration, and a high-order curvature of field upon focusing on infinity occur, and it becomes difficult to correct the aberrations. By the lower limit value of the conditional expression (2) being set at 0.40, 0.50, 0.60, 0.70, and 0.80, the effects of the present embodiment can be made more reliable.

In the optical system OL according to the present embodiment, the following conditional expression (3) is preferably satisfied:

$$1.1 < f 4 / f 3 < 2 \text{.60} \qquad ( 3 )$$

where f4: a focal length of the fourth lens group.

The conditional expression (3) specifies an appropriate range of a ratio of the focal length between the fourth lens group G4 and the third lens group G3. As a result of the conditional expression (3) being satisfied, various aberrations such as the spherical aberration and the curvature of field can be favorably corrected.

If a corresponding value of the conditional expression (3) exceeds an upper limit value, refractive power of the fourth lens group becomes too weak, and thus, a lens radius becomes large, and it becomes difficult to achieve a smaller size. By the upper limit value of the conditional expression (3) being set at 2.50, 2.40, 2.30, 2.20, and 2.10, the effects of the present embodiment can be made more reliable.

If the corresponding value of the conditional expression (3) falls below a lower limit value, the refractive power of the fourth lens group becomes too strong, and thus, a high-order spherical aberration and a high-order curvature of field occur, and it becomes difficult to correct the aberrations. By the lower limit value of the conditional expression (3) being set at 1.20, 1.30, 1.40, 1.50, and 1.60, the effects of the present embodiment can be made more reliable.

In the optical system OL according to the present embodiment, the following conditional expression (4) is preferably satisfied:

$$0.35 < ( - f 5 ) / f 3 < 2 \text{.50} \qquad ( 4 )$$

where f5: a focal length of the fifth lens group G5.

The conditional expression (4) specifies an appropriate range of a ratio of the focal length between the fifth lens group G5 and the third lens group G3. As a result of the conditional expression (4) being satisfied, various aberrations such as the curvature of field and the distortion can be favorably corrected.

If a corresponding value of the conditional expression (4) exceeds an upper limit value, refractive power of the fifth lens group becomes too weak, and thus, a lens radius becomes large, and it becomes difficult to achieve a smaller size. By the upper limit value of the conditional expression (4) being set at 2.40, 2.30, 2.20, 2.10, and 2.00, the effects of the present embodiment can be made more reliable.

If the corresponding value of the conditional expression (4) falls below a lower limit value, the refractive power of the fifth lens group becomes too strong, and thus, a high-order curvature of field and a high-order distortion occur, and it becomes difficult to correct the aberrations. By the lower limit value of the conditional expression (4) being set at 0.50, 0.70, 0.80, 0.90, and 1.00, the effects of the present embodiment can be made more reliable.

In the optical system OL according to the present embodiment, the following conditional expression (5) is preferably satisfied:

$$0.3 < D 1 / D 3 < 2 \text{.00} \qquad ( 5 )$$

where D1: a length on the optical axis from a lens surface closest to the object of the first lens group to a lens surface closest to an image surface of the first lens group
D3: a length on the optical axis from a lens surface closest to the object of the third lens group to a lens surface closest to an image surface of the third lens group.

The conditional expression (5) specifies an appropriate range of a ratio of the length of the first lens group to the length of the third lens group on the optical axis. As a result of the conditional expression (5) being satisfied, various aberrations such as the spherical aberration, the coma aberration, a longitudinal chromatic aberration can be favorably corrected.

If a corresponding value of the conditional expression (5) exceeds an upper limit value, the length of the first lens group becomes too long, and thus, it becomes difficult to correct the spherical aberration and the coma aberration. By the upper limit value of the conditional expression (5) being set at 1.80, 1.70, 1.60, 1.50, and 1.40, the effects of the present embodiment can be made more reliable.

If the corresponding value of the conditional expression (5) falls below a lower limit value, the length of the third lens group becomes too long, and thus, it becomes difficult to correct the curvature of field and the distortion. By the lower limit value of the conditional expression (5) being set at 0.40, 0.50, 0.60, 0.70, and 0.80, the effects of the present embodiment can be made more reliable.

In the optical system OL according to the present embodiment, the following conditional expression (6) is preferably satisfied:

$$0.01 < D 2 / D 3 < 0 \text{.20} \qquad ( 6 )$$

where D2: a length on the optical axis from a lens surface closest to the object of the second lens group to a lens surface closest to the image surface of the second lens group
D3: a length on the optical axis from a lens surface closest to the object of the third lens group to a lens surface closest to the image surface of the third lens group.

The conditional expression (6) specifies an appropriate range of a ratio of the length of the second lens group to the length of the third lens group on the optical axis. As a result of the conditional expression (6) being satisfied, various aberrations such as the spherical aberration, the coma aberration and the longitudinal chromatic aberration can be favorably corrected.

If a corresponding value of the conditional expression (6) exceeds an upper limit value, the length of the second lens group becomes too long, and thus, it becomes difficult to correct the spherical aberration and the coma aberration. By the upper limit value of the conditional expression (6) being set at 0.18, 0.16, 0.14, 0.12, and 0.10, the effects of the present embodiment can be made more reliable.

If the corresponding value of the conditional expression (6) falls below a lower limit value, the length of the third lens group becomes too long, and thus, it becomes difficult to correct the curvature of field and the distortion. By the lower limit value of the conditional expression (6) being set at 0.02 and 0.03, the effects of the present embodiment can be made more reliable.

In the optical system OL according to the present embodiment, the following conditional expression (7) is preferably satisfied:

$$0.01 < D 4 / D 3 < 1 \text{.00} \qquad ( 7 )$$

where D4: a length on the optical axis from a lens surface closest to the object of the fourth lens group to a lens surface closest to the image surface of the fourth lens group
   D3: a length on the optical axis from the lens surface closest to the object of the third lens group to the lens surface closest to the image surface of the third lens group.

The conditional expression (7) specifies an appropriate range of a ratio of the length of the fourth lens group to the length of the third lens group on the optical axis. As a result of the conditional expression (7) being satisfied, various aberrations such as the spherical aberration, the coma aberration and the longitudinal chromatic aberration can be favorably corrected.

If a corresponding value of the conditional expression (7) exceeds an upper limit value, the length of the fourth lens group becomes too long, and thus, it becomes difficult to correct the spherical aberration and the coma aberration. By the upper limit value of the conditional expression (7) being set at 0.90, 0.80, 0.70, 0.60, and 0.50, the effects of the present embodiment can be made more reliable.

If the corresponding value of the conditional expression (7) falls below a lower limit value, the length of the third lens group becomes too long, and thus, it becomes difficult to correct the curvature of field and the distortion. By the lower limit value of the conditional expression (7) being set at 0.04, 0.06, 0.08, 0.10, and 0.12, the effects of the present embodiment can be made more reliable.

In the optical system OL according to the present embodiment, the following conditional expression (8) is preferably satisfied:

$$0.01 < D 5 / D 3 < 1 \text{.50} \qquad ( 8 )$$

where D5: a length on the optical axis from a lens surface closest to the object of the fifth lens group to a lens surface closest to the image surface of the fifth lens group
D3: a length on the optical axis from a lens surface closest to the object of the third lens group to a lens surface closest to the image surface of the third lens group.

The conditional expression (8) specifies an appropriate range of a ratio of the length of the fifth lens group to the length of the third lens group on the optical axis. As a result of the conditional expression (8) being satisfied, various aberrations such as the spherical aberration, the coma aberration and the longitudinal chromatic aberration can be favorably corrected.

If a corresponding value of the conditional expression (8) exceeds an upper limit value, the length of the fifth lens group becomes too long, and thus, it becomes difficult to correct the spherical aberration and the coma aberration. By the upper limit value of the conditional expression (8) being set at 1.20, 1.00, 0.90, 0.80, and 0.70, the effects of the present embodiment can be made more reliable.

If the corresponding value of the conditional expression (8) falls below a lower limit value, the length of the third lens group becomes too long, and thus, it becomes difficult to correct the curvature of field and the distortion. By the lower limit value of the conditional expression (8) being set at 0.02, 0.03, 0.04, 0.05, and 0.06, the effects of the present embodiment can be made more reliable.

In the optical system OL according to the present embodiment, the following conditional expression (9) is preferably satisfied:

$$0.05 < ( - f 2 ) / f 4 < 1.4 \qquad ( 9 )$$

where f2: a focal length of the second lens group
f4: a focal length of the fourth lens group.

The conditional expression (9) specifies an appropriate range of a ratio of the focal length between the second lens group and the fourth lens group that move upon focusing. As a result of the conditional expression (9) being satisfied, various aberrations can be favorably corrected from infinity to a closest range.

If a corresponding value of the conditional expression (9) exceeds an upper limit value, the refractive power of the second lens group becomes too weak, and thus, an amount of movement of the second lens group becomes large, and an entire length of the optical system becomes long. By the upper limit value of the conditional expression (9) being set at 1.20, 1.00, 0.90, 0.80, and 0.70, the effects of the present embodiment can be made more reliable.

If the corresponding value of the conditional expression (9) falls below a lower limit value, the refractive power of the second lens group becomes too strong, and thus, a spherical aberration occurs, and fluctuation of the spherical aberration becomes large from infinity to the closest range upon focusing, and thus, it becomes difficult to correct the aberrations. By the lower limit value of the conditional expression (9) being set at 0.10, 0.20, 0.30, and 0.40, the effects of the present embodiment can be made more reliable.

In the optical system OL according to the present embodiment, the following conditional expression (10) is preferably satisfied.

$$0.25 < Mv 2 / Mv 4 < 1 \text{.35} \qquad ( 10 )$$

where Mv2: an absolute value of an amount of movement on the optical axis of the second lens group upon focusing
Mv4: an absolute value of an amount of movement on the optical axis of the fourth lens group upon focusing

The conditional expression (10) specifies an appropriate range of a ratio of a movement distance on the optical axis between the second lens group and the fourth lens group that move upon focusing. As a result of the conditional expression (10) being satisfied, various aberrations can be favorably corrected from infinity to the closest range. Note that in the present embodiment, the amount of movement of the second lens group upon focusing is an amount of movement of the second lens group upon focusing on a short-distance object from an infinity object. Further, the amount of movement of the fourth lens group upon focusing is an amount of movement of the fourth lens group upon focusing on the short-distance object from the infinity object.

If a corresponding value of the conditional expression (10) exceeds an upper limit value, the amount of movement of the second lens group becomes large, and the entire length of the optical system becomes long. By the upper limit value of the conditional expression (10) being set at 1.30, 1.25, 1.20, 1.15, and 1.10, the effects of the present embodiment can be made more reliable.

If the corresponding value of the conditional expression (10) falls below a lower limit value, the refractive power of the second lens group becomes too strong, and thus, fluctuation of the spherical aberration and the coma aberration from infinity to the closest range becomes large upon focusing, and thus, it becomes difficult to correct the aberrations. By the lower limit value of the conditional expression (10) being set at 0.30, 0.35, 0.40, 0.45, and 0.50, the effects of the present embodiment can be made more reliable.

In the optical system OL according to the present embodiment, the following conditional expression (11) is preferably satisfied.

$$1. < β2 / β4 < 10 \text{.00} \qquad ( 11 )$$

where β2: a lateral magnification of the second lens group
β4: a lateral magnification of the fourth lens group

The conditional expression (11) specifies an appropriate range of a ratio of the lateral magnification between the second lens group and the fourth lens group that are focusing groups. As a result of the conditional expression (11) being satisfied, various aberrations can be favorably corrected from infinity to the closest range. Note that in the present embodiment, the lateral magnification of the second lens group is a lateral magnification of the second lens group upon focusing on infinity. Further, the lateral magnification of the fourth lens group is a lateral magnification of the fourth lens group upon focusing on infinity.

If a corresponding value of the conditional expression (11) exceeds an upper limit value, the lateral magnification of the second lens group becomes too large, and fluctuation of the spherical aberration and the coma aberration becomes large upon focusing, and thus, it becomes difficult to correct the aberrations. By the upper limit value of the conditional expression (11) being set at 9.00, 8.00, 7.00, 6.50, and 6.00, the effects of the present embodiment can be made more reliable.

If the corresponding value of the conditional expression (11) falls below a lower limit value, the lateral magnification of the second lens group becomes small, and the amount of movement of the second lens group upon focusing becomes large, and the entire length of the optical system becomes long. By the lower limit value of the conditional expression (11) being set at 1.50, 2.00, 2.50, 2.75, and 3.00, the effects of the present embodiment can be made more reliable.

In the optical system OL according to the present embodiment, the second lens group preferably consists of one single lens. By the second lens group including one single lens, the optical system can be made lighter. As a result of the optical system being made lighter, for example, a step motor can be used for driving.

In the optical system OL according to the present embodiment, the fourth lens group preferably consists of one cemented lens. By the fourth lens group including one cemented lens, fluctuation of a chromatic aberration upon focusing can be suppressed.

The optical system OL according to the present embodiment preferably includes an aperture stop that is disposed closer to the image than the second lens group. By the aperture stop being provided closer to the image than the second lens group, the spherical aberration can be corrected from infinity to the closest range.

In the optical system OL according to the present embodiment, the following conditional expression (12) and conditional expression (13) are preferably satisfied.

$$1.8 < nd 1 \qquad ( 12 )$$

$$17. < vd 1 < 35. \qquad ( 13 )$$

where nd1: a refractive index based on a d-line of a lens closest to the object in the optical system OL
νd1: an Abbe number based on the d-line of the lens closest to the object in the optical system OL

The conditional expression (12) specifies an appropriate range of the refractive index of the lens closest to the object in the optical system OL according to the present embodiment. As a result of the conditional expression (12) being satisfied, occurrence of the longitudinal chromatic aberration can be suppressed.

If a corresponding value of the conditional expression (12) falls below a lower limit value, it becomes difficult to suppress fluctuation of the longitudinal chromatic aberration that is to occur. By the lower limit value of the conditional expression (12) being set at 1.85 and 1.90, the effects of the present embodiment can be made more reliable. Further, by an upper limit value of the conditional expression (12) being set at 2.00, the effects of the present embodiment can be made more reliable.

The conditional expression (13) specifies an appropriate range of the Abbe number of the lens closest to the object in the optical system OL according to the present embodiment. As a result of the conditional expression (13) being satisfied, occurrence of the longitudinal chromatic aberration can be suppressed.

If a corresponding value of the conditional expression (13) exceeds an upper limit value, it becomes difficult to suppress fluctuation of the longitudinal chromatic aberration that is to occur. By the upper limit value of the conditional expression (13) being set at 34.00, 33.00, 32.00, and 31.00, the effects of the present embodiment can be made more reliable.

If the corresponding value of the conditional expression (13) falls below a lower limit value, it becomes difficult to suppress fluctuation of the longitudinal chromatic aberration that is to occur. By the lower limit value of the conditional expression (13) being set at 18.50, 19.00, 19.50, and 20.00, the effects of the present embodiment can be made more reliable.

The fifth lens group of the optical system OL according to the present embodiment preferably includes at least one lens for which the following conditional expression (14) and conditional expression (15) are satisfied.

$$1.8 < nd 2 \qquad ( 14 )$$

$$17. < vd 2 < 35. \qquad ( 15 )$$

where nd2: a refractive index based on a d-line of a lens of the fifth lens group of the optical system OL
νd2: an Abbe number based on the d-line of the lens of the fifth lens group of the optical system OL

The conditional expression (14) specifies an appropriate range of the refractive index of the lens of the fifth lens group of the optical system OL according to the present embodiment. Further, the conditional expression (15) specifies an appropriate range of the Abbe number of the lens of the fifth lens group of the optical system OL according to the present embodiment. As a result of the fifth lens group having a lens for which the conditional expressions (14) and (15) are satisfied, a chromatic aberration of magnification can be favorably corrected.

If a corresponding value of the conditional expression (14) falls below a lower limit value, it becomes difficult to suppress fluctuation of the chromatic aberration of magnification that is to occur. By the lower limit value of the conditional expression (14) being set at 1.85 and 1.90, the effects of the present embodiment can be made more reliable. Further, by an upper limit value of the conditional expression (14) being set at 2.00, the effects of the present embodiment can be made more reliable.

If a corresponding value of the conditional expression (15) exceeds an upper limit value, it becomes difficult to suppress fluctuation of the chromatic aberration of magnification that is to occur. By the upper limit value of the conditional expression (15) being set at 34.00, 33.00, 32.00, and 31.00, the effects of the present embodiment can be made more reliable.

If the corresponding value of the conditional expression (15) falls below a lower limit value, it becomes difficult to suppress fluctuation of the chromatic aberration of magnification that is to occur. By the lower limit value of the conditional expression (15) being set at 18.50, 19.00, 19.50, and 20.00, the effects of the present embodiment can be made more reliable.

In the optical system OL according to the present embodiment, the third lens group preferably includes at least five lenses. As a result of the third lens group including at least five lenses, the spherical aberration and the coma aberration can be efficiently corrected.

In the optical system OL according to the present embodiment, the third lens group preferably includes at least two cemented lenses. As a result of the third lens group including at least two cemented lenses, the longitudinal chromatic aberration can be efficiently corrected.

Concerning the lens closest to the object in the optical system OL according to the present embodiment, the following conditional expression (16) is preferably satisfied.

$$1. < ( L 1 r 1 + L 1 r 2 ) / ( L 1 r 2 - L 1 r 1 ) < 9. \qquad ( 16 )$$

where L1r1: a radius of curvature of an object-side lens surface of the lens closest to the object in the optical system OL
L1r2: a radius of curvature of an image surface-side lens surface of the lens closest to the object in the optical system OL

The conditional expression (16) specifies an appropriate range of a relationship between the radius of curvature on the object side and the radius of curvature on the image surface side of the lens disposed closest to the object in the optical system OL according to the present embodiment. As a result of the conditional expression (16) being satisfied, occurrence of the spherical aberration can be suppressed.

If a corresponding value of the conditional expression (16) exceeds an upper limit value, a difference in curvature between the object-side lens surface and the image surface-side lens surface in the lens closest to the object becomes too small, and it becomes difficult to correct various aberrations such as the spherical aberration. By the upper limit value of the conditional expression (16) being set at 8.00, 7.00, 6.50, 6.00, and 5.50, the effects of the present embodiment can be made more reliable.

If the corresponding value of the conditional expression (16) falls below a lower limit value, the image surface-side lens surface in the lens closest to the object becomes too moderate, and thus, it becomes difficult to correct the spherical aberration. By the lower limit value of the conditional expression (16) being set at 1.10, 1.20, 1.30, 1.40, and 1.50, the effects of the present embodiment can be made more reliable.

In the optical system OL according to the present embodiment, the following conditional expression (17) is preferably satisfied.

$$5. ° < ω < 16. ° \qquad ( 17 )$$

where ω: a half angle of view of the optical system OL upon focusing on infinity

The conditional expression (17) specifies an appropriate range of the half angle of view of the optical system OL according to the present embodiment. As a result of the conditional expression (17) being satisfied, a bright optical system can be implemented.

To make the effects of the present embodiment reliable, an upper limit value of the conditional expression (17) is preferably set at 15.00°. By the upper limit value of the conditional expression (17) being set at 14.00°, 13.00°, 12.00°, and further 11.00°, the effects of the present embodiment can be made more reliable. To make the effects of the present embodiment reliable, a lower limit value of the conditional expression (17) is preferably set at 6.00°. By the lower limit value of the conditional expression (17) being set at 7.00° and further 8.00°, the effects of the present embodiment can be made more reliable.

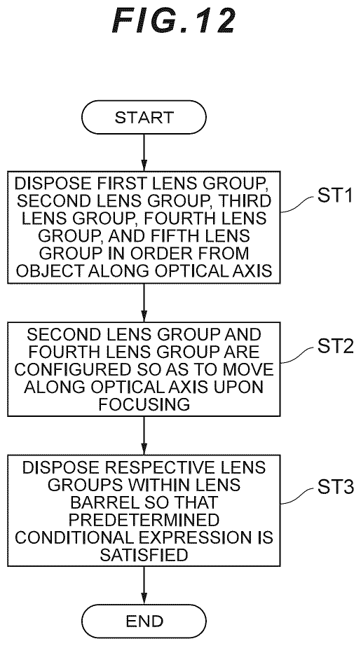

Subsequently, outline of a method for manufacturing the optical system OL according to the present embodiment will be described with reference to FIG. 12. First, the first lens group G1 having positive refractive power, the second lens group G2 having negative refractive power, the third lens group G3 having positive refractive power, the fourth lens group G4 having positive refractive power, and the fifth lens group G5 having negative refractive power are disposed in order from the object along the optical axis (step ST1). Then, the second lens group G2 and the fourth lens group G4 are disposed so as to move along the optical axis upon focusing (step ST2). Then, respective lenses are disposed within a lens barrel so that the above-described conditional expression (1) is satisfied (step ST3). According to such a manufacturing method, it is possible to manufacture a bright optical system having favorable optical performance.

### EXAMPLES

Optical systems OL according to examples of the present embodiment will be described below based on the drawings. FIGS. 1, 3, 5, 7 and 9 are cross-sectional views illustrating configurations of the optical systems OL (OL (1) to OL (5)) according to first to fifth examples. FIGS. 1, 3, 5, 7 and 9 indicate moving directions along the optical axis of the respective lens groups upon focusing on a short-distance object from an infinity object with arrows.

In FIGS. 1, 3, 5, 7 and 9, the respective lens groups are indicated with combinations of a reference sign G and numbers, and further, respective lenses are indicated with combinations of a reference sign L and numbers. In this case, to prevent types and numbers of the reference signs and the numbers from increasing and becoming complicated, the lens groups, and the like, are indicated using combinations of the reference signs and the numbers independently for each example. Thus, even if the same combination of the reference signs and the numbers is used between the examples, it does not mean to indicate that the examples have the same configuration.

Among Tables 1 to 5 which will be indicated below, Table 1 is a table indicating data in the first example, Table 2 is a table indicating data in the second example, Table 3 is a table indicating data in the third example, Table 4 is a table indicating data in the fourth example, and Table 5 is a table indicating data in the fifth example. In each example, as calculation targets of aberration characteristics, a d-line (wavelength λ=587.6 nm) and a g-line (wavelength λ=435.8 nm) are selected.

In a table of [General Data], f indicates a focal length upon focusing on infinity in the whole lens system, FNO indicates an F number upon focusing on infinity, ω indicates a half angle of view (unit is ° (degree)) upon focusing on infinity, and Y indicates an image height. TL indicates a distance obtained by adding back focusing (Bf) to a distance on the optical axis from the lens surface closest to the object in the optical system to the lens surface closest to the image surface, and Bf indicates a distance on the optical axis (air equivalent distance) from the lens surface closest to the image surface in the optical system to the image surface.

Further, in the table of [General Data], each of D1 to D5 indicates a length on the optical axis from the lens surface closest to the object in each lens group to the lens surface closest to the image in each lens group in each of the first to the fifth lens groups. Mv2 and Mv4 respectively indicate absolute values of the amounts of movement of the second lens group and the fourth lens group upon focusing on a short-distance object from upon focusing on infinity. β2 and β4 respectively indicate lateral magnifications of the second lens group and the fourth lens group upon focusing on infinity.

In a table of [Lens Data], a surface number indicates order of optical surfaces from the object along a direction in which a light beam travels, R indicates a radius of curvature of each optical surface (where a surface on which the center of curvature is located on the image side is set at a positive value), D indicates a surface distance that is a distance on the optical axis from the optical surface to the next optical surface (or the image surface), nd indicates a refractive index with respect to the d-line (wavelength λ=587.6 nm) of a material of an optical member, and νd indicates an Abbe number based on the d-line of the material of the optical member. “∞” of the radius of curvature indicates a plane or an aperture, an aperture stop S indicates an aperture stop S. Description of a refractive index of air nd=1.00000 is omitted. In a case where the optical surface is an aspherical surface, a mark * is assigned to the surface number, and a paraxial radius of curvature is indicated in a field of the radius R of curvature.

In a table of [Aspherical surface data], a shape of the aspherical surface indicated in the [Lens Data] is indicated with the following expression (A). X(y) indicates a distance (sag amount) in the optical axis direction from a tangent plane at a vertex of the aspherical surface to a position on the aspherical surface in a height y, R indicates a radius of curvature (paraxial radius of curvature) of a reference spherical surface, K indicates a conic constant, and Ai indicates an i-th order aspherical coefficient. “E-n” indicates “×10⁻ⁿ”. For example, 1.234 E−05=1.234×10⁻⁵. Note that a second-order aspherical coefficient A2 is 0, and description thereof is omitted.

$$x ( y ) = ( {y}^{2} / R ) / \{ 1 + {( 1 - κ \times {y}^{2} / {R}^{2} )}^{1 / 2} \} + A 4 + \times {y}^{4} + A 6 \times {y}^{6} + A 8 \times {y}^{8} + A 10 \times {y}^{10} \qquad ( A )$$

In a table of [variable Distance Data], a surface number i of a first surface for which a surface distance is (variable) in the table of [Lens Data] is indicated, and a surface distance upon focusing on infinity and a surface distance upon focusing on a short-distance object are respectively indicated. In the table of [Variable Distance Data], f indicates a focal length, FNO indicates an F number, and ω indicates a half angle of view each upon focusing on infinity and upon focusing on a short-distance object.

A table of [Lens group data] indicates a first surface (surface closest to the object) of each lens group and a focal length.

Hereinafter, while in all data values, “mm” is typically used as unit of the indicated focal length f, the radius R of curvature, the surface distance D, other lengths, and the like, unless otherwise specified, in the optical system, equivalent optical performance can be obtained even if proportional magnification or proportional reduction is performed, and thus, the unit is not limited to this.

The description of the tables described so far is common among all the examples, and redundant description will be omitted below.

### First Example

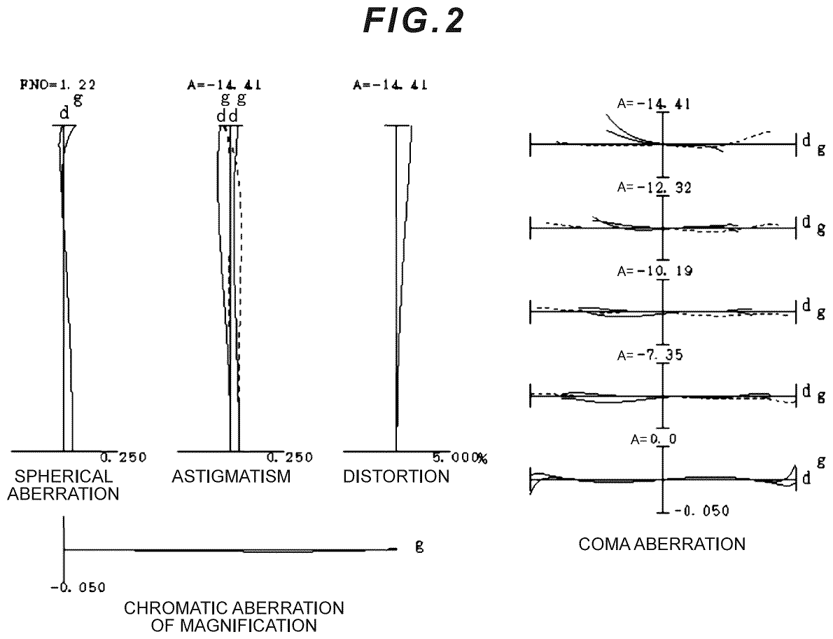

The first example will be described using FIG. 1 to FIG. 2 and Table 1. FIG. 1 is a view illustrating a lens configuration of the optical system according to the first example. The optical system OL (1) according to the first example includes the first lens group G1 having positive refractive power, the second lens group G2 having negative refractive power, the third lens group G3 having positive refractive power, the fourth lens group G4 having positive refractive power, and the fifth lens group having negative refractive power, disposed in order from the object along the optical axis. Upon focusing on the short-distance object from the infinity object, the second lens group G2 and the fourth lens group G4 move along the optical axis, specifically, the second lens group G2 moves toward the image surface, and the fourth lens group G4 moves toward the object, and a distance between the adjacent lens groups changes. Note that upon focusing, positions of the first lens group G1, the third lens group G3, and the fifth lens group G5 are fixed with respect to the image surface I. A sign (+) or (−) assigned to a symbol of each lens group indicates refractive power of each lens group, which is similar to all the examples described below.

The second lens group G2 which is the first focusing group is disposed closer to the object than the aperture stop S. Upon focusing, a position of the aperture stop S is fixed with respect to the image surface I. In the present example, the aperture stop S is disposed between the second lens group G2 and the third lens group G3.

The first lens group G1 includes a positive meniscus lens L11 having a convex surface facing the object, a positive meniscus lens L12 having a convex surface facing the object, a cemented lens in which a biconvex positive lens L13 and a biconcave negative lens L14 are cemented, and a positive meniscus lens L15 having a convex surface facing the object, disposed in order from the object along the optical axis. The positive meniscus lens L15 has an aspherical lens surface on the object side. Note that the lens L11 of the first lens group G1 is a lens for which the above-described conditional expressions (12) and (13) are satisfied.

The second lens group G2 includes a biconcave negative lens L21. Upon focusing, the second lens group G2 moves toward the image surface I along the optical axis. The aperture stop S is disposed on the image side of the second lens group G2.

The third lens group G3 includes a cemented lens in which a biconcave negative lens L31 and a positive meniscus lens L32 having a convex surface facing the object are cemented, a cemented lens in which a biconcave negative lens L33 and a biconvex positive lens L34 are cemented, and a biconvex positive lens L35, disposed in order from the object along the optical axis.

The fourth lens group G4 includes a cemented lens in which a negative meniscus lens L41 having a convex surface facing an object and a biconvex positive lens L42 disposed in order from the object along the optical axis, are cemented. Upon focusing, the fourth lens group G4 moves toward the object along the optical axis.

The fifth lens group G5 includes a cemented lens in which a biconvex positive lens L51 and a biconcave negative lens L52 are cemented, and a negative meniscus lens L53 having a convex surface facing the image surface, disposed in order from the object along the optical axis. The negative meniscus lens L53 has an aspherical surface on the object side. The image surface I is disposed on the image side of the fifth lens group G5. Note that the lens L51 of the fifth lens group G5 is a lens for which the above-described conditional expressions (14) and (15) are satisfied.

Table 1 below indicates values of data of the optical system according to the first example.

TABLE 1
[General Data]

| | |
|---|---|
| f = 83.30 | FNO = 1.22 |
| ω = 14.39 | Y = 21.70 |
| TL = 145.02 | Bf = 11.50 |
| Mv2 = 6.89 | Mv4 = 6.64 |
| β2 = 3.79 | β4 = 0.75 |
| D1 = 35.39 | D2 = 1.30 |
| D3 = 29.96 | D4 = 11.70 |
| D5 = 18.96 | |

[Lens Data]

| Surface | | | | |
|---|---|---|---|---|
| number | R | D | nd | νd |
| 1 | 61.3155 | 6.543 | 1.94595 | 17.98 |
| 2 | 95.1815 | 1.285 | | |
| 3 | 84.7805 | 7.210 | 1.81600 | 46.59 |
| 4 | 323.5639 | 0.200 | | |
| 5 | 77.2601 | 8.687 | 1.59319 | 67.90 |
| 6 | −515.0260 | 1.300 | 1.85451 | 25.15 |
| 7 | 40.7856 | 4.333 | | |
| 8* | 63.6376 | 5.837 | 1.77387 | 47.25 |
| 9 | 1378.4972 | (Variable) | | |
| 10 | −1499.6903 | 1.300 | 1.59349 | 67.00 |
| 11 | 45.3666 | (Variable) | | |
| 12 | ∞ | 2.525 | | (Aperture |
| | | | | Stop) |
| 13 | −429.1609 | 1.300 | 1.85451 | 25.15 |
| 14 | 30.9100 | 9.020 | 1.77250 | 49.62 |
| 15 | 157.0117 | 2.898 | | |
| 16 | −186.8927 | 1.300 | 1.64769 | 33.72 |
| 17 | 50.9242 | 8.366 | 1.81600 | 46.59 |
| 18 | −219.8810 | 0.200 | | |
| 19 | 91.3080 | 6.882 | 2.00100 | 29.12 |
| 20 | −144.4633 | (Variable) | | |
| 21 | 70.4787 | 1.200 | 1.73037 | 32.23 |
| 22 | 34.1041 | 10.500 | 1.48749 | 70.32 |
| 23 | −108.2548 | (Variable) | | |
| 24 | 340.1508 | 6.914 | 1.94595 | 17.98 |
| 25 | −51.1451 | 1.300 | 1.68893 | 31.16 |
| 26 | 70.8470 | 9.453 | | |
| 27* | −32.4845 | 1.300 | 1.77387 | 47.25 |
| 28 | −58.2682 | Bf | | |

[Aspherical surface data]
8th surface
κ = 0.0000, A4 = −1.22983E−06, A6 = −6.07719E−10,
A8 = −2.08389E−13, A10 = −1.26545E−17
27th surface
κ = 0.0000, A4 = −1.76143E−06, A6 = 8.47789E−10,
A8 = −1.34054E−12, A10 = 2.89728E−15

[Variable Distance Data]

| | | Upon focusing |
|---|---|---|
| First | Upon focusing | on a short- |
| surface | on infinity | distance object |
| 9 | 3.427 | 10.312 |
| 11 | 16.149 | 9.264 |
| 20 | 9.929 | 3.292 |
| 23 | 3.643 | 10.280 |
| 28(Bf) | 11.501 | 11.501 |

| | | Upon focusing |
|---|---|---|
| | Upon focusing | on a short- |
| | on infinity | distance object |
| f | 83.30 | 77.92 |
| FNO | 1.22 | 1.29 |
| ω | 14.39 | 12.63 |

[Lens group data]

| | Starting | Focal |
|---|---|---|
| Group | surface | length |
| G1 | 1 | 83.651 |
| G2 | 10 | −74.173 |
| G3 | 13 | 71.443 |
| G4 | 21 | 130.572 |
| G5 | 24 | −82.516 |

FIG. 2 is various aberration diagrams upon focusing on infinity of the optical system according to the first example. In each aberration diagram upon focusing on infinity, FNO indicates an F number, and A indicates a maximum shooting half angle of view in a negative direction. Note that the spherical aberration diagram indicates the F number or a numerical aperture corresponding to a maximum aperture, the astigmatism diagram and distortion diagram indicate a maximum value of the half angle of view, and the coma aberration diagram indicates values of the half angles of view. d indicates the d-line (wavelength λ=587.6 nm), and g indicates the g-line (wavelength λ=435.8 nm). In the astigmatism diagram, a solid line indicates a sagittal image surface, and a dashed line indicates a meridional image surface. Note that also in the aberration diagrams in the respective examples described below, reference numerals similar to those in the present example will be used, and redundant description will be omitted.

It can be seen from the respective aberration diagrams that the optical system according to the first example has excellent imaging performance as a result of the various aberrations being favorably corrected.

### Second Example

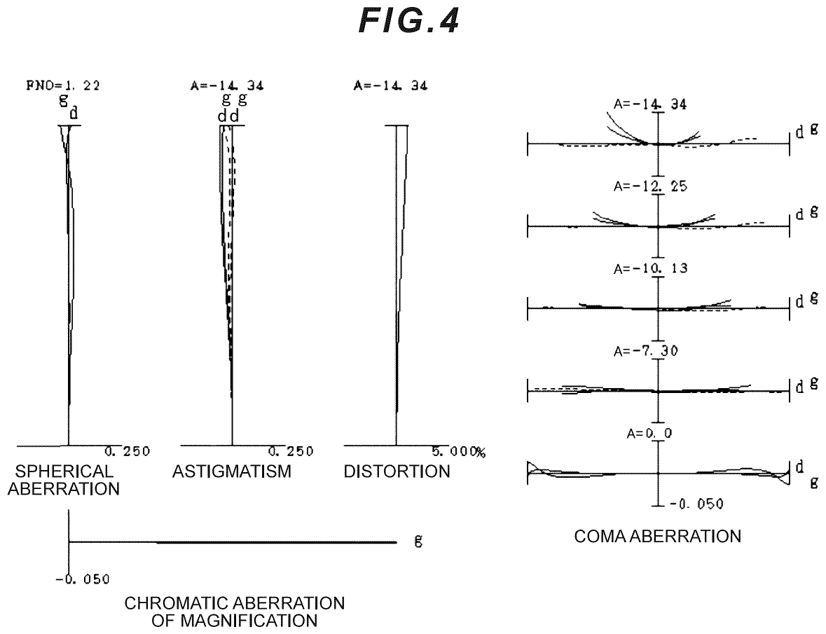

The second example will be described using FIG. 3 to FIG. 4 and Table 2. FIG. 3 is a view illustrating a lens configuration of the optical system according to the second example. The optical system OL (2) according to the second example includes the first lens group G1 having positive refractive power, the second lens group G2 having negative refractive power, the third lens group G3 having positive refractive power, the fourth lens group G4 having positive refractive power, and the fifth lens group G5 having negative refractive power, disposed in order from the object along the optical axis. Upon focusing on the short-distance object from the infinity object, the second lens group G2 and the fourth lens group G4 move along the optical axis, specifically, the second lens group G2 moves toward the image surface, and the fourth lens group G4 moves toward the object, and a distance between the adjacent lens groups changes. Note that upon focusing, positions of the first lens group G1, the third lens group G3 and the fifth lens group G5 are fixed with respect to the image surface I.

The second lens group G2 which is the first focusing group is disposed closer to the object than the aperture stop S. Upon focusing, a position of the aperture stop S is fixed with respect to the image surface I. In the present example, the aperture stop S is disposed between the second lens group G2 and the third lens group G3.

The first lens group G1 includes a positive meniscus lens L11 having a convex shape facing the object, a positive meniscus lens L12 having a convex surface facing the object, a cemented lens in which a positive meniscus lens L13 having a convex surface facing the object and a negative meniscus lens L14 having a convex surface facing the object are cemented, and a positive meniscus lens L15 having a convex surface facing the object, disposed in order from the object along the optical axis. The positive meniscus lens L15 has aspherical lens surfaces on the object side and on the image surface side. Note that the lens L11 of the first lens group G1 is a lens for which the above-described conditional expressions (12) and (13) are satisfied.

The second lens group G2 includes a biconcave negative lens L21. Upon focusing, the second lens group G2 moves toward the image surface I along the optical axis. The aperture stop S is disposed on the image side of the second lens group G2.

The third lens group G3 includes a cemented lens in which a negative meniscus lens L31 having a convex surface facing the object and a positive meniscus lens L32 having a convex surface facing the object are cemented, a cemented lens in which a biconvex positive lens L33 and a negative meniscus lens L34 having a convex surface facing the image surface are cemented, and a biconvex positive lens L35, disposed in order from the object along the optical axis. The positive meniscus lens L32 has an aspherical lens surface on the image surface side.

The fourth lens group G4 includes a cemented lens in which a negative meniscus lens L41 having a convex surface facing the object and a biconvex positive lens L42 disposed in order from the object along the optical axis, are cemented. Upon focusing, the fourth lens group G4 moves toward the object along the optical axis.

The fifth lens group G5 includes a cemented lens in which a biconvex positive lens L51 and a biconcave negative lens L52 are cemented, and a negative meniscus lens L53 having a convex surface facing the image surface, disposed in order from the object along the optical axis. The image surface I is disposed on the image side of the fifth lens group G5. Note that the lens L51 of the fifth lens group G5 is a lens for which the above-described conditional expressions (14) and (15) are satisfied.

Table 2 below indicates values of data of the optical system according to the second example.

TABLE 2
[General Data]

| | |
|---|---|
| f = 84.00 | FNO = 1.22 |
| ω = 14.32 | Y = 21.70 |
| TL = 143.45 | Bf = 11.45 |
| Mv2 = 6.52 | Mv4 = 9.50 |
| β2 = 4.12 | β4 = 0.77 |
| D1 = 37.33 | D2 = 1.30 |
| D3 = 30.44 | D4 = 6.46 |
| D5 = 20.16 | |

[Lens Data]

| Surface | | | | |
|---|---|---|---|---|
| number | R | D | nd | νd |
| 1 | 62.162 | 7.425 | 1.94595 | 17.98 |
| 2 | 100.200 | 0.200 | | |
| 3 | 64.115 | 8.926 | 1.81600 | 46.59 |
| 4 | 183.532 | 0.200 | | |
| 5 | 72.522 | 7.644 | 1.59319 | 67.90 |
| 6 | 903.917 | 1.300 | 1.85451 | 25.15 |
| 7 | 33.749 | 6.643 | | |
| 8* | 66.140 | 4.996 | 1.77387 | 47.25 |
| 9* | 1245.502 | (Variable) | | |
| 10 | −913.526 | 1.300 | 1.59349 | 67.00 |
| 11 | 47.413 | (Variable) | | |
| 12 | ∞ | 2.000 | | (Aperture |
| | | | | Stop) |
| 13 | 4679730700.000 | 1.300 | 1.85451 | 25.15 |
| 14 | 33.354 | 6.749 | 1.77387 | 47.25 |
| 15* | 83.430 | 0.942 | | |
| 16 | 90.066 | 13.681 | 1.59319 | 67.90 |
| 17 | −33.917 | 1.300 | 1.85451 | 25.15 |
| 18 | −100.285 | 0.200 | | |
| 19 | 257.954 | 6.272 | 2.00100 | 29.12 |
| 20 | −78.220 | (Variable) | | |
| 21 | 447.932 | 1.200 | 1.73037 | 32.23 |
| 22 | 169.223 | 5.263 | 1.59349 | 67.00 |
| 23 | −93.679 | (Variable) | | |
| 24 | 104.313 | 5.827 | 1.94595 | 17.98 |
| 25 | −141.295 | 1.300 | 1.48749 | 70.32 |
| 26 | 39.370 | 11.741 | | |
| 27 | −34.506 | 1.300 | 1.66755 | 41.87 |
| 28 | −84.493 | Bf | | |

[Aspherical surface data]
8th surface
κ = 0.0000, A4 = −2.11299E−06, A6 = −2.43648E−09,
A8 = −3.66048E−13, A10 =−3.32443E−15
9th surface
κ = 0.0000, A4 = −7.29914E−07, A6 = −1.42899E−09,
A8 = 1.27633E−13, A10 = −2.81470E−15
15th surface
κ = 0.0000, A4 = −6.20554E−07, A6 = −9.52337E−10,
A8 = 4.89159E−13, A10 = −1.28599E−16

[Variable Distance Data]

| | | Upon focusing |
|---|---|---|
| First | Upon focusing | on a short- |
| surface | on infinity | distance object |
| 9 | 2.869 | 9.387 |
| 11 | 15.038 | 8.519 |
| 20 | 12.952 | 3.452 |
| 23 | 3.433 | 12.933 |
| 28(Bf) | 11.455 | 11.455 |

| | | Upon focusing |
|---|---|---|
| | Upon focusing | on a short- |
| | on infinity | distance object |
| f | 84.00 | 77.56 |
| FNO | 1.22 | 1.47 |
| ω | 14.32 | 12.72 |

[Lens group data]

| | Starting | Focal |
|---|---|---|
| Group | surface | length |
| G1 | 1 | 90.428 |
| G2 | 10 | −75.908 |
| G3 | 13 | 72.486 |
| G4 | 21 | 140.183 |
| G5 | 24 | −94.816 |

FIG. 4 is variable aberration diagrams upon focusing on infinity of the optical system according to the second example. It can be seen from the various aberration diagrams that the optical system according to the second example has excellent imaging performance as a result of the various aberrations being favorably corrected.

### Third Example

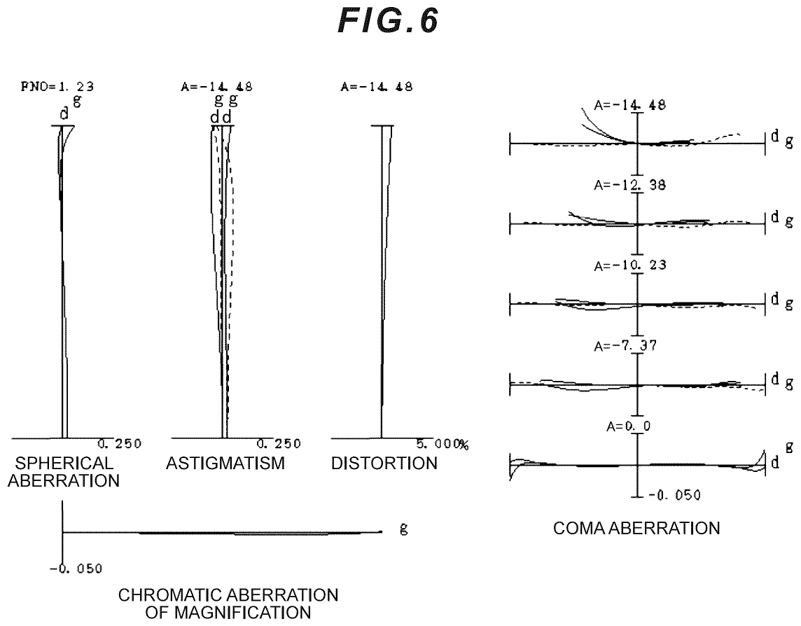

The third example will be described using FIG. 5 to FIG. 6 and Table 3. FIG. 5 is a view illustrating a lens configuration of the optical system according to the third example. The optical system OL (3) according to the third example includes the first lens group G1 having positive refractive power, the second lens group G2 having negative refractive power, the third lens group G3 having positive refractive power, the fourth lens G4 group having positive refractive power, and the fifth lens group having negative refractive power, disposed in order from the object along the optical axis. Upon focusing on the short-distance object from the infinity object, the second lens group G2 and the fourth lens group G4 move along the optical axis, specifically, the second lens group G2 moves toward the image surface, and the fourth lens group G4 moves toward the object, and a distance between the adjacent lens groups changes. Note that upon focusing, positions of the first lens group G1, the third lens group G3, and the fifth lens group G5 are fixed with respect to the image surface I.

The second lens group G2 which is the first focusing group is disposed closer to the object than the aperture stop S. Upon focusing, a position of the aperture stop S is fixed with respect to the image surface I. In the present example, the aperture stop S is disposed between the second lens group G2 and the third lens group G3.

The first lens group G1 includes a positive meniscus lens L11 having a convex surface facing the object, a positive meniscus lens L12 having a convex surface facing the object, a cemented lens in which a biconvex positive lens L13 and a biconcave negative lens L14 are cemented, and a positive meniscus lens L15 having a convex surface facing the object, disposed in order from the object along the optical axis. The positive meniscus lens L15 has an aspherical lens surface on the object side. Note that the lens L11 of the first lens group G1 is a lens for which the above-described conditional expressions (12) and (13) are satisfied.

The second lens group G2 includes a biconcave negative lens L21. Upon focusing, the second lens group G2 moves toward the image surface I along the optical axis. The aperture stop S is disposed on the image side of the second lens group G2.

The third lens group G3 includes a cemented lens in which a biconcave negative lens L31 and a positive meniscus lens L32 having a convex surface facing the object are cemented, a cemented lens in which a biconcave negative lens L33 and a biconvex positive lens L34 are cemented, and a biconvex positive lens L35, disposed in order from the object along the optical axis.

The fourth lens group G4 includes a cemented lens in which a negative meniscus lens L41 having a convex surface facing the object and a biconvex positive lens L42 disposed in order from the object along the optical axis, are cemented. Upon focusing, the fourth lens group G4 moves toward the object along the optical axis.

The fifth lens group G5 includes a cemented lens in which a biconvex positive lens L51 and a biconcave negative lens L52 are cemented, and a negative meniscus lens L53 having a convex surface facing the image surface, disposed in order from the object along the optical axis. The image surface I is disposed on the image side of the fifth lens group G5. Note that the lens L51 of the fifth lens group G5 is a lens for which the above-described conditional expressions (14) and (15) are satisfied.

Table 3 below indicates values of data of the optical system according to the third example.

TABLE 3
[General Data]

| | |
|---|---|
| f = 83.30 | FNO = 1.23 |
| ω = 14.46 | Y = 21.70 |
| TL = 145.02 | Bf = 12.02 |
| Mv2 = 6.79 | Mv4 = 6.85 |
| β2 = 3.80 | β4 = 0.77 |
| D1 = 35.55 | D2 = 1.30 |
| D3 = 28.93 | D4 = 11.69 |
| D5 = 18.90 | |

[Lens Data]

| Surface | | | | |
|---|---|---|---|---|
| number | R | D | nd | νd |
| 1 | 59.9279 | 6.428 | 1.94595 | 17.98 |
| 2 | 91.0546 | 2.170 | | |
| 3 | 90.4631 | 6.857 | 1.81600 | 46.59 |
| 4 | 386.0343 | 0.200 | | |
| 5 | 76.3859 | 8.815 | 1.59319 | 67.90 |
| 6 | −390.4620 | 1.300 | 1.85451 | 25.15 |
| 7 | 41.5253 | 3.866 | | |
| 8* | 62.1251 | 5.924 | 1.77387 | 47.25 |
| 9 | 2207.3961 | (Variable) | | |
| 10 | −1370.2398 | 1.300 | 1.59349 | 67.00 |
| 11 | 44.3647 | (Variable) | | (Aperture |
| 12 | ∞ | 3.014 | | Stop) |
| 13 | −218.4283 | 1.300 | 1.85451 | 25.15 |
| 14 | 31.6342 | 8.649 | 1.77250 | 49.62 |
| 15 | 145.6235 | 2.425 | | |
| 16 | −360.5752 | 1.300 | 1.64769 | 33.72 |
| 17 | 53.0851 | 7.877 | 1.81600 | 46.59 |
| 18 | −267.9552 | 0.200 | | |
| 19 | 86.0527 | 7.183 | 2.00100 | 29.12 |
| 20 | −140.4959 | (Variable) | | |
| 21 | 75.3546 | 1.200 | 1.73037 | 32.23 |
| 22 | 34.3845 | 10.500 | 1.48749 | 70.32 |
| 23 | −106.5385 | (Variable) | | |
| 24 | 162.1662 | 6.698 | 1.94595 | 17.98 |
| 25 | −62.2969 | 1.300 | 1.69895 | 30.13 |
| 26 | 64.2213 | 9.603 | | |
| 27 | −31.8768 | 1.300 | 1.80400 | 46.60 |
| 28 | −57.9365 | Bf | | |

[Aspherical surface data]
8th surface
κ = 0.0000, A4 = −1.26996E−06, A6 = −6.43821E−10,
A8 = −2.11857E−13, A10 = −2.16058E−17

[Variable Distance Data]

| | | Upon focusing on |
|---|---|---|
| First | Upon focusing on | a short-distance |
| surface | infinity | object |
| 9 | 3.321 | 10.107 |
| 11 | 16.026 | 9.240 |
| 20 | 10.341 | 3.490 |
| 23 | 3.902 | 10.754 |
| 28(Bf) | 12.024 | 12.024 |

| | | Upon focusing on |
|---|---|---|
| | Upon focusing on | a short-distance |
| | infinity | object |
| f | 83.30 | 77.84 |
| FNO | 1.23 | 1.31 |
| ω | 14.46 | 12.65 |

[Lens group data]

| | Starting | Focal |
|---|---|---|
| Group | surface | length |
| G1 | 1 | 81.597 |
| G2 | 10 | −72.383 |
| G3 | 13 | 72.498 |
| G4 | 21 | 140.159 |
| G5 | 24 | −85.205 |

FIG. 6 is various aberration diagrams upon focusing on intensity of the optical system according to the third example. It can be seen from the various aberration diagrams that the optical system according to the third example has excellent imaging performance as a result of the various aberrations being favorably corrected.

### Fourth Example

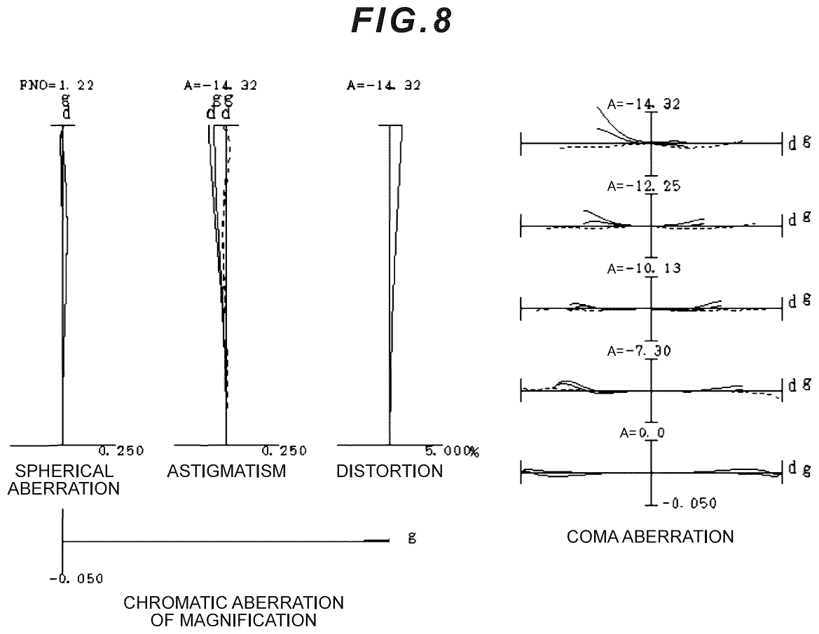

The fourth example will be described using FIG. 7 to FIG. 8 and Table 4. FIG. 7 is a view illustrating a lens configuration of the optical system according to the fourth example. The optical system OL (4) according to the fourth example includes the first lens group G1 having positive refractive power, the second lens group G2 having negative refractive power, the third lens group G3 having positive refractive power, the fourth lens group G4 having positive refractive power, and the fifth lens group G5 having negative refractive power, disposed in order from the object along the optical axis. Upon focusing on the short-distance object from the infinity object, the second lens group G2 and the fourth lens group G4 move along the optical axis, specifically, the second lens group G2 moves toward the image surface, and the fourth lens group G4 moves toward the object, and a distance between the adjacent lens groups changes. Note that upon focusing, positions of the first lens group G1, the third lens group G3, and the fifth lens group G5 are fixed with respect to the image surface I.

The second lens group G2 which is the first focusing group is disposed closer to the object than the aperture stop S. Upon focusing, a position of the aperture stop S is fixed with respect to the image surface I. In the present example, the aperture stop S is disposed between the second lens group G2 and the third lens group G3.

The first lens group G1 includes a positive meniscus lens L11 having a convex surface facing the object, a positive meniscus lens L12 having a convex surface facing the object, a cemented lens in which a positive meniscus lens L13 having a convex surface facing the object and a negative meniscus lens L14 having a convex surface facing the object are cemented, and a positive meniscus lens L15 having a convex surface facing the object, disposed in order from the object along the optical axis. The positive meniscus lens L15 has an aspherical lens surface on the object side. Note that the lens L11 of the first lens group G1 is a lens for which the above-described conditional expressions (12) and (13) are satisfied.

The second lens group G2 includes a negative meniscus lens L21 having a convex surface facing the object. The negative meniscus lens L21 has an aspherical lens surface on the image surface side. Upon focusing, the second lens group G2 moves toward the image surface I along the optical axis. The aperture stop S is disposed on the image side of the second lens group G2.

The third lens group G3 includes a cemented lens in which a negative meniscus lens L31 having a convex surface facing the object and a positive meniscus lens L32 having a convex surface facing the object are cemented, a cemented lens in which a biconvex positive lens L33 and a negative meniscus lens L34 having a convex surface facing the image surface are cemented, and a biconvex positive lens L35, disposed in order from the object along the optical axis.

The fourth lens group G4 includes a biconvex positive lens L41. The positive lens L41 has aspherical lens surfaces on the object side and the image surface side. Upon focusing, the fourth lens group G4 moves toward the object along the optical axis.

The fifth lens group G5 includes a cemented lens in which a biconvex positive lens L51 and a biconcave negative lens L52 are cemented, and a negative meniscus lens L53 having a convex surface facing the image surface, disposed in order from the object along the optical axis. The image surface I is disposed on the image side of the fifth lens group G5. Note that the lens L51 of the fifth lens group G5 is a lens for which the above-described conditional expressions (14) and (15) are satisfied.

Table 4 below indicates values of data of the optical system according to the fourth example.

TABLE 4
[General Data]

| | |
|---|---|
| f = 84.00 | FNO = 1.22 |
| ω = 14.31 | Y = 21.70 |
| TL = 146.01 | Bf = 12.01 |
| Mv2 = 5.45 | Mv4 = 9.96 |
| β2 = 4.24 | β4 = 1.14 |
| D1 = 37.57 | D2 = 1.30 |
| D3 = 34.45 | D4 = 5.51 |
| D5 = 20.37 | |

[Lens Data]

| Surface | | | | |
|---|---|---|---|---|
| number | R | D | nd | νd |
| 1 | 61.8660 | 7.301 | 1.94595 | 17.98 |
| 2 | 99.3205 | 0.200 | | |
| 3 | 56.4071 | 9.756 | 1.87070 | 40.73 |
| 4 | 162.0886 | 0.200 | | |
| 5 | 75.3588 | 6.967 | 1.49782 | 82.57 |
| 6 | 677.4242 | 1.300 | 1.85451 | 25.15 |
| 7 | 29.9642 | 6.605 | | |
| 8* | 59.1972 | 5.245 | 1.82098 | 42.50 |
| 9 | 591.8979 | (Variable) | | |
| 10 | 613.2624 | 1.300 | 1.77387 | 47.25 |
| 11* | 54.1013 | (Variable) | | |
| 12 | ∞ | 2.000 | | (Aperture |
| | | | | Stop) |
| 13 | 322.6325 | 1.300 | 1.85451 | 25.15 |
| 14 | 30.9124 | 5.500 | 1.80400 | 46.60 |
| 15 | 52.0972 | 1.837 | | |
| 16 | 65.8373 | 14.813 | 1.59319 | 67.90 |
| 17 | −29.9924 | 1.300 | 1.90265 | 35.72 |
| 18 | −89.2850 | 0.200 | | |
| 19 | 504.9140 | 9.503 | 1.81600 | 46.59 |
| 20 | −48.1379 | (Variable) | | |
| 21* | 293.0826 | 5.509 | 1.59245 | 66.92 |
| 22* | −109.8545 | (Variable) | | |
| 23 | 107.6668 | 6.245 | 1.94595 | 17.98 |
| 24 | −117.6222 | 1.300 | 1.51680 | 64.13 |
| 25 | 36.6373 | 11.531 | | |
| 26 | −35.1736 | 1.300 | 1.66755 | 41.87 |
| 27 | −104.4687 | Bf | | |

[Aspherical surface data]
8th surface
κ = 0.0000, A4 = −1.03346E−06, A6 = −1.49359E−09,
A8 = 7.59970E−13, A10 = −1.22863E−15
11th surface
κ = 0.0000, A4 = 4.40041E−07, A6 = −1.53288E−09,
A8 = 2.57535E−12, A10 = −4.72116E−16
21th surface
κ = 0.0000, A4 = −1.87135E−06, A6 = −5.38955E−09,
A8 = 1.23899E−11, A10 = −1.27359E−14
22th surface
κ = 0.0000, A4 = −1.68434E−06, A6 = −6.06644E−09,
A8 = 1.53712E−11, A10 = −1.54335E−14

[Variable Distance Data]

| | | Upon focusing |
|---|---|---|
| First | Upon focusing | on a short- |
| surface | on infinity | distance object |
| 9 | 2.780 | 8.230 |
| 11 | 13.706 | 8.256 |
| 20 | 13.237 | 3.275 |
| 22 | 3.065 | 13.027 |
| 27(Bf) | 12.007 | 12.007 |

| | | Upon focusing |
|---|---|---|
| | Upon focusing | on a short- |
| | on infinity | distance object |
| f | 84.00 | 75.92 |
| FNO | 1.22 | 1.48 |
| ω | 14.31 | 13.17 |

[Lens group data]

| | Starting | Focal |
|---|---|---|
| Group | surface | length |
| G1 | 1 | 93.455 |
| G2 | 10 | −76.752 |
| G3 | 13 | 66.053 |
| G4 | 21 | 135.561 |
| G5 | 23 | −74.582 |

FIG. 8 is various aberration diagrams upon focusing on infinity of the optical system according to the fourth example. It can be seen from the various aberration diagrams that the optical system according to the fourth example has excellent imaging performance as a result of the various aberrations being favorably corrected.

### Fifth Example

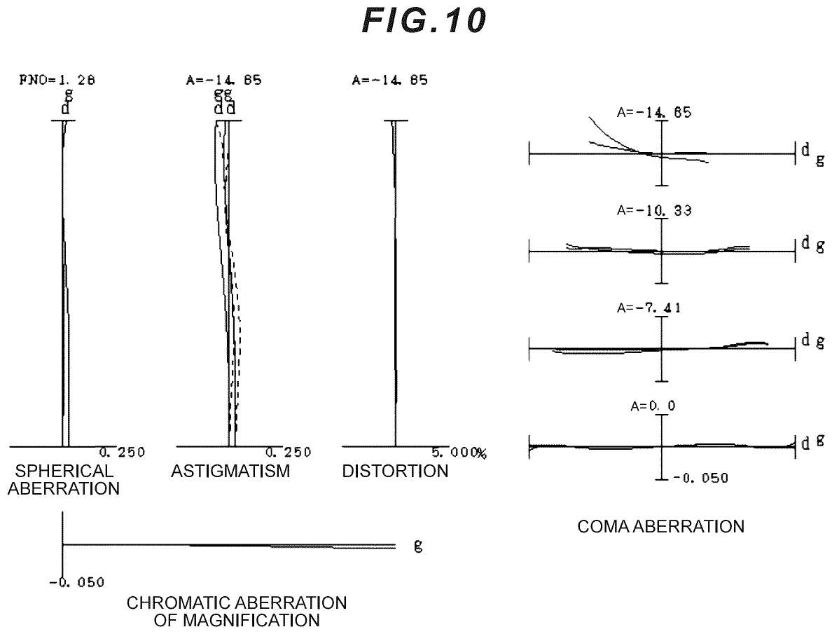

The fifth example will be described using FIG. 9 to FIG. 10 and Table 5. FIG. 9 is a view illustrating a lens configuration of the optical system according to the fifth example. The optical system OL (5) according to the fifth example includes the first lens group G1 having positive refractive power, the second lens group G2 having negative refractive power, the third lens group G3 having positive refractive power, the fourth lens group G4 having positive refractive power, and the fifth lens group having negative refractive power, disposed in order from the object along the optical axis. Upon focusing on the short-distance object from the infinity object, the second lens group G2 and the fourth lens group G4 move along the optical axis, specifically, the second lens group G2 moves toward the image surface, and the fourth lens group G4 moves toward the object, and a distance between the adjacent lens groups changes. Note that upon focusing, positions of the first lens group G1, the third lens group G3, and the fifth lens group G5 are fixed with respect to the image surface I.

The second lens group G2 which is the first focusing group is disposed closer to the object than the aperture stop S. Upon focusing, a position of the aperture stop S is fixed with respect to the image surface I. In the present example, the aperture stop S is disposed between the second lens group G2 and the third lens group G3.

The first lens group G1 includes a positive meniscus lens L11 having a convex surface facing the object, a cemented lens in which a biconvex positive lens L12 and a biconcave negative lens L13 are cemented, and a positive meniscus lens L14 having a convex surface facing the object, disposed in order from the object along the optical axis. The positive meniscus lens L14 has an aspherical lens surface on the object side. Note that the lens L11 of the first lens group G1 is a lens for which the above-described conditional expressions (12) and (13) are satisfied.

The second lens group G2 includes a negative meniscus lens L21 having a convex surface facing the object. Upon focusing, the second lens group G2 moves toward the image surface I along the optical axis. The aperture stop S is disposed on the image side of the second lens group G2.

The third lens group G3 includes a cemented lens in which a biconcave negative lens L31 and a biconvex positive lens L32 are cemented, a cemented lens in which a biconcave negative lens L33 and a positive meniscus lens L34 having a convex surface facing the object are cemented, and a biconvex positive lens L35, disposed in order from the object along the optical axis.

The fourth lens group G4 includes a cemented lens in which a negative meniscus lens L41 having a convex surface facing the object and a positive meniscus lens L42 having a convex surface facing the object disposed in order from the object along the optical axis, are cemented. Upon focusing, the fourth lens group G4 moves toward the object along the optical axis.

The fifth lens group G5 includes a cemented lens in which a biconvex positive lens L51 and a biconcave negative lens L52 are cemented, and a negative meniscus lens L53 having a convex surface facing the image surface, disposed in order from the object along the optical axis. The negative meniscus lens L53 has an aspherical lens surface on the object side. The image surface I is disposed on the image side of the fifth lens group G5. Note that the lens L51 of the fifth lens group G5 is a lens for which the above-described conditional expressions (14) and (15) are satisfied.

Table 5 below indicates values of data of the optical system according to the fifth example.

TABLE 5
[General Data]

| | |
|---|---|
| f = 83.35 | FNO = 1.25 |
| ω = 14.63 | Y = 21.70 |
| TL = 147.26 | Bf = 11.99 |
| Mv2 = 8.05 | Mv4 = 8.57 |
| β2 = 2.55 | β4 = 0.75 |
| D1 = 32.54 | D2 = 2.00 |
| D3 = 35.21 | D4 = 8.39 |
| D5 = 25.63 | |

[Lens Data]

| Surface | | | | |
|---|---|---|---|---|
| number | R | D | nd | νd |
| 1 | 58.5212 | 10.855 | 1.92286 | 20.88 |
| 2 | 261.9967 | 1.020 | | |
| 3 | 71.1971 | 9.084 | 1.59319 | 67.90 |
| 4 | −878.2122 | 3.000 | 1.84666 | 23.80 |
| 5 | 42.9748 | 3.325 | | |
| 6* | 60.5565 | 5.263 | 1.69927 | 49.06 |
| 7 | 253.7786 | (Variable) | | |
| 8 | 154.1691 | 2.000 | 1.59319 | 67.90 |
| 9 | 40.9973 | (Variable) | | |
| 10 | ∞ | 2.498 | | (Aperture |
| | | | | Stop) |
| 11 | −99.9831 | 2.000 | 1.84666 | 23.80 |
| 12 | 32.5394 | 13.000 | 1.77290 | 44.96 |
| 13 | −46.3569 | 0.097 | | |
| 14 | −46.6097 | 2.000 | 1.69895 | 30.13 |
| 15 | 38.8903 | 7.973 | 1.83174 | 42.57 |
| 16 | 414.7047 | 4.415 | | |
| 17 | 112.5005 | 5.730 | 1.99138 | 30.25 |
| 18 | −144.1842 | (Variable) | | |
| 19 | 82.2459 | 1.700 | 1.90366 | 31.27 |
| 20 | 38.2538 | 6.690 | 1.75500 | 52.34 |
| 21 | 796.7196 | (Variable) | | |
| 22 | 114.7753 | 12.500 | 1.94594 | 17.98 |
| 23 | −52.0466 | 1.500 | 1.76200 | 40.11 |
| 24 | 61.2649 | 9.127 | | |
| 25* | −41.4348 | 2.500 | 1.80835 | 40.55 |
| 26 | −61.6111 | Bf | | |

[Aspherical surface data]
6th surface
κ = −0.3584, A4 = −1.10237E−06, A6 = −5.09259E−10,
A8 = −3.91082E−13, A10 = 1.89705E−16
25th surface
κ = −1.8812, A4 = −6.55273E−06, A6 = 5.98995E−09,
A8 = −1.98934E−11, A10 = 2.05569E−14

[Variable Distance Data]

| | | Upon focusing |
|---|---|---|
| First | Upon focusing | on a short- |
| surface | on infinity | distance object |
| 7 | 0.490 | 8.542 |
| 9 | 15.925 | 7.874 |
| 18 | 10.573 | 2.000 |
| 21 | 2.000 | 10.573 |
| 26(Bf) | 11.990 | 11.990 |

| | | Upon focusing |
|---|---|---|
| | Upon focusing | on a short- |
| | on infinity | distance object |
| f | 83.35 | 79.81 |
| FNO | 1.25 | 1.31 |
| ω | 14.63 | 12.99 |

[Lens group data]

| | Starting | Focal |
|---|---|---|
| Group | surface | length |
| G1 | 1 | 86.300 |
| G2 | 8 | −94.774 |
| G3 | 11 | 94.148 |
| G4 | 19 | 160.599 |
| G5 | 22 | −174.714 |

FIG. 10 is various aberration diagrams upon focusing on infinity of the optical system according to the fifth example. It can be seen from the various aberration diagrams that the optical system according to the fifth example has excellent imaging performance as a result of the various aberrations being favorably corrected.

A table of [Conditional Expression Corresponding Value] will be indicated next below. This table indicates values corresponding to the respective conditional expressions (1) to (17) as Ex1 to Ex5 for all the examples (first to fifth examples).

$$0.50 < f 1 / f 3 < 2. \qquad Conditional expression ( 1 )$$

$$0.3 < ( - f 2 ) / f 3 < 2.00 \qquad Conditional expression ( 2 )$$

$$1.1 < f 4 / f 3 < 2.60 \qquad Conditional expression ( 3 )$$

$$0.35 < ( - f 5 ) / f 3 < 2.50 \qquad Conditional expression ( 4 )$$

$$0.3 < D 1 / D 3 < 2.00 \qquad Conditional expression ( 5 )$$

$$0.01 < D 2 / D 3 < 0.20 \qquad Conditional expression ( 6 )$$

$$0.01 < D 4 / D 3 < 1.00 \qquad Conditional expression ( 7 )$$

$$0.01 < D 5 / D 3 < 1.50 \qquad Conditional expression ( 8 )$$

$$0.05 < ( - f 2 ) / f 4 < 1.40 \qquad Conditional expression ( 9 )$$

$$0.25 < Mv 2 / Mv 4 < 1.35 \qquad Conditional expression ( 10 )$$

$$1. < β2 / β4 < 10. \qquad Conditional expression ( 11 )$$

$$1.8 < nd 1 \qquad Conditional expression ( 12 )$$

$$17. < vd 1 < 35. \qquad Conditional expression ( 13 )$$

$$1.8 < nd 2 \qquad Conditional expression ( 14 )$$

$$17. < vd 2 < 35. \qquad Conditional expression ( 15 )$$

$$1. < ( L 1 r 1 + L 1 r 2 ) / ( L 1 r 2 - L 1 r 1 ) < 9. \qquad Conditional expression ( 16 )$$

$$5. ° < ω < 16. ° \qquad Conditional expression ( 17 )$$

### [Conditional Expression Corresponding Value] (First to Fifth Example)

| Conditional | First | Second | Third | Fourth | Fifth |
|---|---|---|---|---|---|
| Expression | example | example | example | example | example |
| (1) | 1.171 | 1.248 | 1.126 | 1.415 | 0.917 |
| (2) | 1.038 | 1.047 | 0.998 | 1.162 | 1.007 |
| (3) | 1.828 | 1.934 | 1.933 | 2.052 | 1.706 |
| (4) | 1.155 | 1.308 | 1.175 | 1.129 | 1.856 |
| (5) | 1.181 | 1.226 | 1.229 | 1.091 | 0.924 |
| (6) | 0.043 | 0.043 | 0.045 | 0.038 | 0.057 |
| (7) | 0.391 | 0.212 | 0.404 | 0.160 | 0.238 |
| (8) | 0.633 | 0.662 | 0.653 | 0.591 | 0.728 |
| (9) | 0.568 | 0.541 | 0.516 | 0.566 | 0.590 |
| (10) | 1.037 | 0.686 | 0.990 | 0.547 | 0.939 |
| (11) | 5.014 | 5.361 | 4.955 | 3.706 | 3.386 |
| (12) | 1.946 | 1.946 | 1.946 | 1.946 | 1.923 |
| (13) | 17.980 | 17.980 | 17.980 | 17.980 | 20.880 |
| (14) | 1.946 | 1.946 | 1.946 | 1.946 | 1.946 |
| (15) | 17.980 | 17.980 | 17.980 | 17.980 | 17.980 |
| (16) | 4.621 | 4.268 | 4.851 | 4.304 | 1.575 |
| (17) | 12.626 | 12.723 | 12.651 | 13.172 | 12.996 |

According to the above-described examples, it is possible to implement a bright optical system having favorable optical performance.

The above-described examples indicate one specific example of the present invention, and the present invention is not limited to these.

The following content can be employed as appropriate within a range in which the optical performance of the optical system of the present embodiment is not impaired.

While a configuration having five groups has been described as the examples of the optical system of the present embodiment, the present invention is not limited to this, and the optical system may employ other group configurations (for example, a configuration having six groups, a configuration having seven groups, a configuration having eight groups, and the like). Specifically, the optical system may employ a configuration in which a lens or a lens group is added to a portion closest to the object or closest to the image surface in the optical system of the present embodiment. The optical system may employ a configuration in which a third focusing lens group is added in addition to two focusing lens groups. Note that the lens group indicates a portion having at least one lens separated by an air distance that changes upon focusing.

A vibration-proof lens group may be used that moves a lens group or a partial lens group so as to have components in a direction perpendicular to the optical axis or rotationally moving (swinging) the lens group or the partial lens group in an in-plane direction including the optical axis to correct an image shake caused by a camera shake.

The lens surface may be either formed with a spherical surface or a plane or formed with an aspherical surface. The lens surface is preferably a spherical surface or a plane, because lens processing and assembly adjustment become easy, and degradation in optical performance due to an error in processing and assembly adjustment can be prevented. Further, the lens surface is preferably a spherical surface or a plane because representation performance less deteriorates even in a case where the image surface is displaced.

In a case where the lens surface is an aspherical surface, the aspherical surface may be either an aspherical surface fabricated by a grinding process, a glass molded aspherical surface obtained by forming glass in an aspherical surface shape by a mold, or a composite type aspherical surface obtained by forming a resin on a surface of glass in an aspherical surface shape. Further, the lens surface may be a diffractive surface, or a lens may be a refractive index distribution type lens (GRIN lens) or a plastic lens.

While the aperture stop is preferably disposed to the image surface side of the second lens group that is the first focusing lens group, a frame of the lens may be used as a substitute for a role of the aperture stop without a member as the aperture stop being provided.

An antireflection film having high transmittance in a wide wavelength region may be applied on each lens surface to reduce flare and ghost and achieve optical performance with high contrast.

### EXPLANATION OF NUMERALS AND CHARACTERS

G1 First lens group
G2 Second lens group
G3 Third lens group
G4 Fourth lens group
G5 Fifth lens group
I Image surface
S Aperture stop

1. An optical system comprising a first lens group having positive refractive power, a second lens group having negative refractive power, a third lens group having positive refractive power, a fourth lens group having positive refractive power, and a fifth lens group having negative refractive power, disposed in order from an object along an optical axis, wherein
upon focusing, the second lens group and the fourth lens group move along the optical axis, and
the following conditional expression is satisfied:
$$0.5 < f 1 / f 3 < 2.00$$
where f1: a focal length of the first lens group
f3: a focal length of the third lens group.

2. The optical system according to claim 1, wherein the following conditional expression is satisfied:
$$0.3 < ( - f 2 ) / f 3 < 2.00$$
where f2: a focal length of the second lens group.

3. The optical system according to claim 1, wherein the following conditional expression is satisfied:
$$1.1 < f 4 / f 3 < 2.60$$
where f4: a focal length of the fourth lens group.

4. The optical system according to claim 1, wherein the following conditional expression is satisfied:
$$0.35 < ( - f 5 ) / f 3 < 2.50$$
where f5: a focal length of the fifth lens group.

5. The optical system according to claim 1, wherein the following conditional expression is satisfied:
$$0.3 < D 1 / D 3 < 2.00$$
where D1: a length on the optical axis from a lens surface closest to the object in the first lens group to a lens surface closest to an image surface in the first lens group
D3: a length on the optical axis from a lens surface closest to the object in the third lens group to a lens surface closest to the image surface in the third lens group.

6. The optical system according to claim 1, wherein the following conditional expression is satisfied:
$$0.01 < D 2 / D 3 < 0.2$$
where D2: a length on the optical axis from a lens surface closest to the object in the second lens group to a lens surface closest to the image surface in the second lens group
D3: a length on the optical axis from a lens surface closest to the object in the third lens group to a lens surface closest to the image surface in the third lens group.

7. The optical system according to claim 1, wherein the following conditional expression is satisfied:
$$0.01 < D 4 / D 3 < 1.$$
where D4: a length on the optical axis from a lens surface closest to the object in the fourth lens group to a lens surface closest to the image surface in the fourth lens group
D3: a length on the optical axis from a lens surface closest to the object in the third lens group to a lens surface closest to the image surface in the third lens group.

8. The optical system according to claim 1, wherein the following conditional expression is satisfied:
$$0.01 < D 5 / D 3 < 1.5$$
where D5: a length on the optical axis from a lens surface closest to the object in the fifth lens group to a lens surface closest to the image surface in the fifth lens group
D3: a length on the optical axis from a lens surface closest to the object in the third lens group to a lens surface closest to the image surface in the third lens group.

9. The optical system according to claim 1, wherein the following conditional expression is satisfied:
$$0.05 < ( - f 2 ) / f 4 < 1.4$$
where f2: a focal length of the second lens group
f4: a focal length of the fourth lens group.

10. The optical system according to claim 1, wherein the following conditional expression is satisfied:
$$0.25 < Mv 2 / Mv 4 < 1.35$$
where Mv2: an absolute value of an amount of movement on the optical axis of the second lens group upon focusing
Mv4: an absolute value of an amount of movement on the optical axis of the fourth lens group upon focusing.

11. The optical system according to claim 1, wherein the following conditional expression is satisfied:
$$1. < β2 / β4 < 10.$$
where β2: a lateral magnification of the second lens group
β4: a lateral magnification of the fourth lens group.

12. The optical system according to claim 1, wherein the second lens group consists of one single lens.

13. The optical system according to claim 1, wherein the fourth lens group consists of one cemented lens.

14. The optical system according to claim 1, comprising an aperture stop disposed closer to an image than the second lens group.

15. The optical system according to claim 1, wherein the following conditional expression is satisfied:
$$\begin{matrix}1.8 < nd 1 \\ 17. < vd 1 < 35.\end{matrix}$$
where nd1: a refractive index based on a d-line of a lens closest to the object in the optical system
νd1: an Abbe number based on the d-line of the lens closest to the object in the optical system.

16. The optical system according to claim 1, wherein the fifth lens group includes at least one lens for which the following conditional expression is satisfied:
$$\begin{matrix}1.8 < nd 2 \\ 17. < vd 2 < 35.\end{matrix}$$
where nd2: a refractive index based on a d-line of the lens in the fifth lens group
νd2: an Abbe number based on the d-line of the lens in the fifth lens group.

17. The optical system according to claim 1, wherein the third lens group includes at least five lenses.

18. The optical system according to claim 1, wherein the third lens group includes at least two cemented lenses.

19. The optical system according to claim 1, wherein the following conditional expression is satisfied:
$$1. < ( L 1 r 1 + L 1 r 2 ) / ( L 1 r 2 - L 1 r 1 ) < 9.$$
where L1r1: a radius of curvature of an object-side lens surface of the lens closest to the object in the optical system
L1r2: a radius of curvature of an image surface-side lens surface of the lens closest to the object in the optical system.

20. The optical system according to claim 1, wherein the following conditional expression is satisfied:
$$5. ° < ω < 16. °$$
where ω: a half angle of view of the optical system upon focusing on infinity.

21. An optical device comprising the optical system according to claim 1.

22. A method for manufacturing an optical system including a first lens group having positive refractive power, a second lens group having negative refractive power, a third lens group having positive refractive power, a fourth lens group having positive refractive power, and a fifth lens group having negative refractive power, disposed in order from an object along an optical axis,
upon focusing, the second lens group G2 and the fourth lens group G4 moving along the optical axis, and
the method comprising a step of disposing respective lenses within a lens barrel so that the following conditional expression is satisfied:
$$0.5 < f 1 / f 3 < 2.00$$
where f1: a focal length of the first lens group
f3: a focal length of the third lens group.
